(19) United States
(12) Patent Application Publication
(10) Pub. No.: US 2013/0053988 A1
(43) Pub. Date: Feb. 28, 2013

(54) MONITORING SYSTEM AND OPERATING METHOD THEREOF

(71) Applicant: LIANG-TSE LIN, New Taipei City (TW)

(72) Inventor: LIANG-TSE LIN, New Taipei City (TW)

(73) Assignees: Liang-Tse Lin, New Taipei City (TW); San Der Saving Energy Technology LTD., New Taipei City (TW)

(21) Appl. No.: 13/594,806

(22) Filed: Aug. 25, 2012

(30) Foreign Application Priority Data
Aug. 26, 2011 (TW) 100130785

(51) Int. Cl. G05B 15/02

(52) U.S. Cl. 700/83

(57) ABSTRACT

A monitoring system includes a sensor unit, a controller unit, a user interface unit, and a server unit. The monitoring system, through connecting the sensor unit with the user interface unit, transmits a data message from the sensor unit to the user interface unit. The user interface unit computes and generates a controller command message corresponding to the data message and a user setting. The controller unit receives the controller command signal through the server unit, wherein the server unit does not need to know the internet protocol addresses of the sensor unit, the user interface unit, and the controller unit ahead of time to be able to successfully transmit the data message and the controller command message.

### BACKGROUND

1. Technical Field

The present invention generally relates to monitoring system and an operating method thereof; particularly to an open monitoring system and an operating method thereof for use with a network.

2. Description of the Related Art

Monitoring systems typically transmit data collected from sensors to a server machine through communication methods, such as serial transmission methods. Use of monitoring systems in central monitoring controls is widespread, with its application relevant to energy conservation management, digital homes, medical care, and other related fields. Consequently, data monitoring of monitoring systems are important.

In terms of the application to energy management and energy conservation as an example, as human population continues to grow, cities are gradually expanding. Along with the growth of cities and metropolitans, various devices also are rapidly being used in large quantities, greatly increasing the levels of energy consumption. As corporations look for ways to increase profits, effective conservation of energy to reduce costs has become a key aspect of staying competitive in the marketplace. Correspondingly, many corporations have implemented energy conservation efforts by installing various sensors among devices that are at the center of the energy conservation efforts. In this manner, these devices may be monitored and controlled such that various data thereof may be collected and analyzed to design new effective energy conservation methods. Unfortunately, in terms of current methods of collecting and processing data, there is a large cost associated with setting up an energy conservation monitoring system. As well, the installation of such system is time consuming and tedious.

FIG. 1 illustrates a conventional monitoring system 10 applied to a central monitoring system. As shown in FIG. 1, the monitoring system 10 includes a sensor 20, a controller 30, and a server 40. The sensor 20 typically senses changes to a target device that a user wants to monitor, and then accordingly generates and transmits a data message to the server 40. The server 40 is installed with a logic processing program to process the data message and generate a controller command for the controller 30. The logic processing program is typically installed in a memory 45 of the server 40. Sensors 20 of the conventional monitoring system 10 are typically exclusively set, customized, or programmed for a particular central monitoring system. If there is a need to construct another monitoring system, the other monitoring system would need to be redesigned from the ground up to suit the location of that monitoring system. This means that sensors of that monitoring system would need to be customized for the new location. In addition, in the conventional monitoring system 10, sensors 20 are connected to the server 40 through serial communication means or through the internet. If the sensors 20 are connected to the server 40 through the serial communication method, the installation location of the server 40 with the sensors 20 and the controller 30 is restricted to being installed in the vicinity of each other such that the sensors 20 and the controllers 30 may not be located too far from the server 40. On the other hand, if the monitoring system 10 is connected through use of the Internet, static IP addresses would need to be set for the sensors 20, the controllers 30, and the server 40 in order for each unit to have the IP address of the other units so that data transmissions or commands may be communicated correctly to the right unit. In the two scenarios described above, if users would like to increase other sensors 20 or controllers 30, the logical computational program of the server 40 would need to be revised to include those new sensors and/or controllers. However, since the logical computational program of the server 40 is a program specifically written tailor-made for the custom monitoring system, revision of the program of the server 40 would have to be carried out by an engineer having considerable knowledge of the monitoring system 10 as well as being fluent in the programming details of the program. Unfortunately, even if such an engineer was located, the probability that the engineer would also be knowledgeable in designing energy conservation programs or strategies is very low. Conversely, persons knowledgeable in designing energy conservation programs aren't able to realize their energy conservation strategies/programs due to the fact that they aren't able to be sufficiently knowledgeable in each different customized monitoring system. In order to overcome such difficulties, there is a need to raise the flexibility, openness, and convenience levels of monitoring systems so that users may quickly and efficiently build new monitoring systems or add on to existing monitoring systems. At the same time, there is a need for that same monitoring system to allow different users to independently design their own energy conservation strategies/programs.

### SUMMARY OF THE INVENTION

It is an object of the present invention to provide an operating method for a monitoring system to overcome the problem of logic computing being concentrated within the server unit of the monitoring unit, causing the monitoring system to not have any flexibility or openness.

It is another object of the present invention to provide a monitoring system, through the Internet, to enable a plurality of sensor units and controller units having dynamic internet protocol addresses to be connected to a plurality of user interface units having dynamic internet protocol addresses through a server unit having a static internet protocol address, such that at any time the amount of sensor units, controller units, or user interface units may be increased or decreased to give the monitoring system an open-source quality.

It is yet another object of the present invention to provide a monitoring system utilizing a plurality of user interface units to allow different users to design programs of logic computation such that users with little programming experience may also easily be effective in realizing energy conservation programs on the monitoring system.

The present invention provides a monitoring system, which through increasing number of sensor units, user interface units, and controller units, allows users to easily and quickly build the monitoring system to conduct energy conservation programs.

The monitoring system includes at least a sensor unit, at least a controller unit, a server unit, and at least a user interface unit. The sensor unit is for generating a data message, wherein the data message includes a sensor identification code. The controller unit is for generating a controller connection message and for receiving a controller command message, wherein the controller connection message includes a controller identification code. The user interface unit is for receiving the data message and is for generating a user interface connection message and the controller command message. The user interface unit generates the controller command message according to the data message and a user setting. The user interface connection message includes a target sensor identification, and the controller command message includes a target controller identification. The server unit is for receiving the data message, the controller connection message, the user interface connection message, and the controller command message. When the sensor identification code of the data message corresponds to the target sensor identification of the user interface connection message, the server unit transmits the data message to the user interface unit where the user interface unit generates the controller command message according to the data message and the user setting and then transmits the controller command message to the server unit. When the controller identification code of the controller connection message corresponds to the target controller identification of the controller command message, the server unit transmits the controller command message to the controller unit.

The operating method of the monitoring system includes: generating a data message in the sensor unit for the server unit to receive, wherein the data message includes a sensor identification code; generating a user interface connection message for the server unit to receive, wherein the user interface connection message includes a target sensor identification; generating a controller connection message in the controller unit for the server unit to receive, wherein the controller connection message includes a controller identification code; comparing the sensor identification code and the target sensor identification, and then enabling the server unit to transmit the data message to the user interface unit when the sensor identification code corresponds to the target sensor identification; generating a controller command in the user interface unit according to a user setting and the data message, and then transmitting the controller command to the server unit; and comparing the controller identification code and the target controller identification, and transmitting the controller command message to the controller unit when the controller identification code corresponds to the target controller identification.

### BRIEF DESCRIPTION OF THE DRAWINGS

FIG. 1 is a schematic view of the conventional monitoring system;

FIG. 2A is an embodiment of the present invention of a monitoring system;

FIG. 2B is another embodiment of FIG. 2A;

FIG. 3 is a flowchart of the monitoring system of the present invention;

FIG. 4A is an embodiment of an user interface unit of the present invention;

FIG. 4B is another embodiment of the user interface unit of the present invention;

FIG. 4C is another embodiment of the user interface unit of the present invention;

FIG. 4D is another embodiment of the user interface unit of the present invention; and

FIG. 5 is another flowchart of the present invention.

### DETAILED DESCRIPTION

The present invention provides a monitoring system and an operating method thereof. In a preferred embodiment, users may easily, quickly, and simply view and analyze data through the monitoring system of the present invention from locations involving digital homes, medical care, companies, factories, or any other locations requiring energy conservation. From the analysis of the data, users may design and freely implement energy conservation programs by controlling the controller units of the monitoring system.

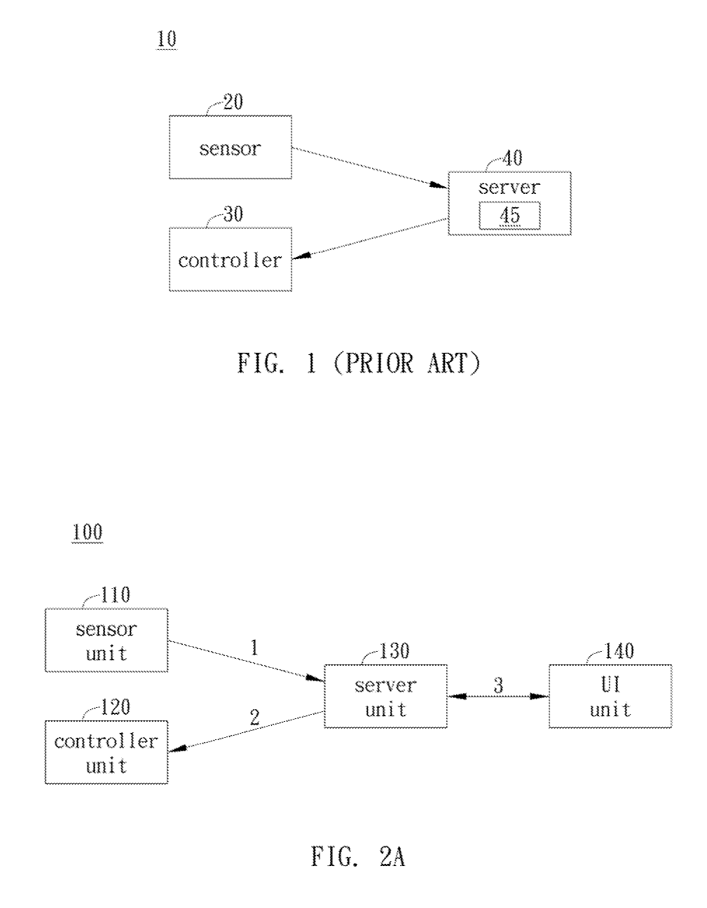

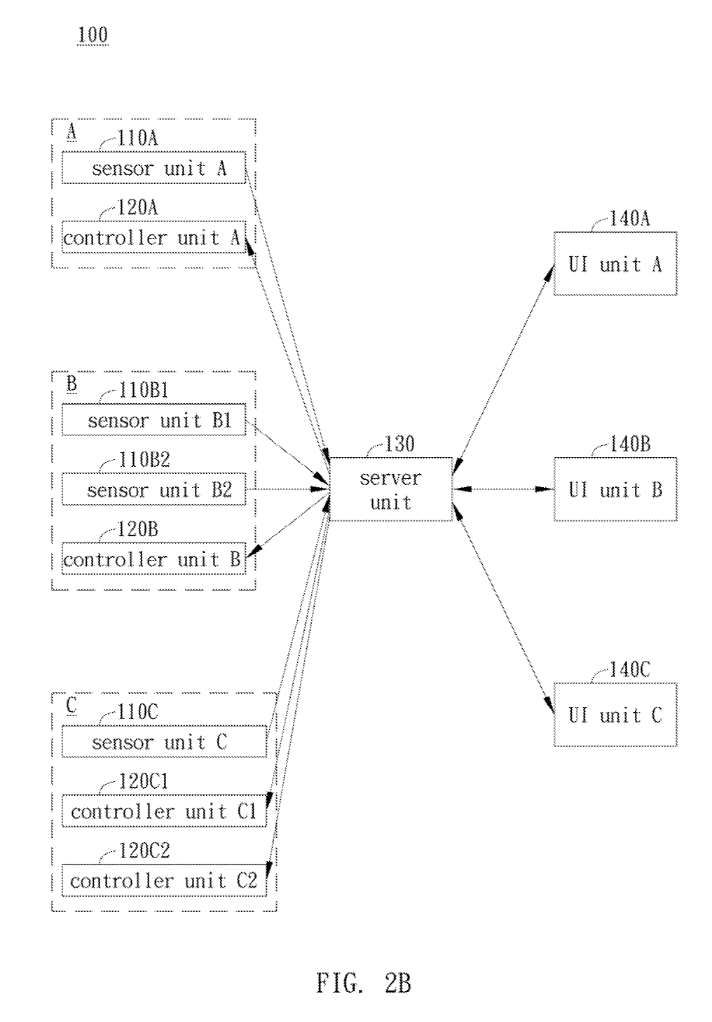

FIG. 2 illustrates an embodiment of the monitoring system 100 of the present invention. In its most basic form, the monitoring system 100 includes at least a sensor unit 110, at least a controller unit 120, a server unit 130, and a user interface unit (herein referred to as “UI unit”) 140. In a preferred embodiment, the sensor unit 110 may include electronic devices with sensing capabilities such as temperature sensors, electrical voltage sensors, electrical current sensors, and the like. In more concrete terms, the sensor unit 110 may sense temperature, sound, humidity, luminance or light levels, electrical voltage, electrical current, electrical resistance, frequency, acceleration, capacitance, inductance, conductance, acidity, or any combination thereof. However, the sensor unit 110 is not limited to only being able to sense the above mentioned. The controller unit 120 may be any electronic device that may be controlled to affect the data sensed by the sensor unit 110. For instance, the controller unit 120 may be a controller that can raise/drop the temperature, sound, humidity, light, electrical voltage, electrical current, electrical resistance, frequency, acceleration, capacitance, inductance, conductance, and acidity levels, or any combination thereof. The server unit 130 includes being an electronic device that can connect with the sensor unit 110, the controller unit 120, and the UI unit 140, allowing them to communicate data between each other through the server unit 130. In an embodiment, the server unit 130 is a server device or a computing device. In the present embodiment, the sensor unit 110, the controller unit 120, and the UI unit 140 is connected to the server unit 130 through a network such as the Internet. The sensor unit 110, the controller unit 120, and the UI unit 140 each have a dynamic Internet Protocol Address (dynamic IP address), whereas the server unit 130 has a static Internet Protocol Address (static IP address). In the present embodiment, the sensor unit 110, the controller unit 120, and the UI unit 140 are connected through Ethernet cables, wireless internet (such as WIFI), Zigbee, Zwave, Bluetooth, and other like communication connections. One characteristic of the monitoring system 100 of the present invention is that even if the dynamic IP addresses of the sensor unit 110, the controller unit 120, and the UI unit 140 are not pre-recorded in the server unit 130, the server unit 130 can still know their dynamic IP addresses when they proactively notify it of them. The server unit 130 is then able to provide a communication method between the sensor unit 110, the controller unit 120, and the UI unit 140. The following will further describe the connection method above in greater detail.

As shown in FIG. 2A, the server unit 130 is connected to the sensor unit 110, the controller unit 12, and the UI unit 140, wherein the connections are labeled as connection lines 1, 2, and 3. As FIG. 2A shows, the sensor unit 110 can be installed at a location such as a company, a factory, or the like. The sensor unit 110 has a dynamic IP address. Upon sensing a change in the target that the sensor unit 110 is monitoring, such as quantifiable environmental measurements like changes in temperature and the like, the sensor unit 110 will generate a data message according to the sensed changes. The data message includes a sensor identification code (herein referred to as “SIC”), wherein the SIC may be composed of any numerical, textual character, or any combination thereof. As an example, a SIC may be combinations such as “AAA”, “1234”, “A2B3”. The sensor unit 110, as a default, has a record of the static IP address of the server unit 130. The sensor unit 110 communicably connects with the server unit 130 with the static IP address on record through the Internet (shown as connection 1 if FIG. 2A), and then transmits the generated data message to the server unit 130. At the same time, the UI unit 140 as a default also has a record of the static IP address of the server unit 130, transmitting an user interface connection message (herein referred to as “UI connection message”) to the server unit 130, wherein the UI connection message includes a target sensor identification. The target sensor identification (herein referred to as “target SID”) represents the sensor identification code (SIC) of the sensor unit 110 that the UI unit 140 would like to receive data messages from. In other words, if the monitoring system has a sensor unit A with SIC of “AAA”, in the case that the UI unit 140 would like to receive data messages from the sensor unit A, the UI unit 140 would only need to set its target SID to be “AAA” of the SIC. In the present embodiment, the UI unit 140 will first transmit the UI connection message including the target SID to the static IP address that the server unit 130 is at through the Internet. When the server unit 130 receives the UI connection message, the server unit 130 will at this point in time compare any SIC that it has received with the target SID of the UI connection message. If there are any matches found, the server unit 130 will transmit the data message of the sensor unit 110 having the SIC corresponding to the target SID to the UI unit 140. In a preferred embodiment, when the server unit 130 receives from the UI unit 140 the UI connection message, the server unit 130 will wait for a default wait time for sensor unit 110 to proactively contact or connect with the server unit 130. However, the present invention is not limited in this aspect. In other different embodiments, if the sensor unit 110 has a static IP address or if the sensor unit 110 had already connected with the server unit 130 before, the server unit 130 will have a record of IP address of the sensor unit 110 and can proactively request of the sensor unit 110 the data message so that the server unit 130 can quickly transmit the data message to the UI unit 140.

As shown in FIG. 2A, when the UI unit 140 receives the data message, the UI unit 140 will generate a controller command message according to the data message and a user setting. In a preferred embodiment, the UI unit 140 is an electronic device having logic computational programming capabilities, such as a laptop computer, handheld electronic devices such as smart phones, or any other large sized electronic devices. The UI unit 140 may also be realized as a software program within an electronic device. However, the UI unit 140 is not limited to this as the UI unit 140 may be realized as purely hardware, such as an input interface of physical buttons with settings that may be set. Users may input monitoring settings through the interface of the UI unit 140, with the UI unit 140 thereafter generating the user setting according to these inputted settings. According to the user setting and the data message, the UI unit 140 will generate the controller command message, wherein the controller command message includes a target controller identification (herein referred to as “target CID”). In similar fashion to the target SID, the target CID represents a controller identification code of the controller unit 120 that the UI unit 140 would like to control. After the UI unit 140 has generated the controller command message, the UI unit 140 will transmit the controller command message to the server unit 130. As described for the transmittance of the data message between the sensor unit 110 and the UI unit 140, the server unit 130 will compare the controller identification code of the controller unit 120 with the target CID in the controller command message received from the UI unit 140. The server unit 130 will then transmit the controller command message to the corresponding controller unit 120 if it is found that the controller identification code and the target CID match or correspond to each other. Upon receiving the controller command message from the controller unit 120, the controller unit 120 will according to the controller command message output a control action or message, actions such as modulating the voltage, temperature, humidity level. In a preferred embodiment, the range that the controller unit 120 can control is preferably related to what sensor units 110 in a same grouping as the controller unit 120 can sense. For instance, if a sensor unit 110 that senses temperature is paired with a controller unit 120, the range that the controller unit 120 can control is preferably related to the temperature that the sensor unit 110 can sense, such as turning on/off an air conditioning. However, in other different embodiments, the relationship between sensor units 110 and controller units 120 is not limited to this as the sensor units 110 and controller units 120 may be grouped together even if they do not have any relationship between them. In other words, the control action or message outputted by the controller unit 120 does not necessarily need to be able to affect the data sensed by the sensor unit 110 such that the generated data message generated by the sensor unit 110 has been affected by the actions of the controller unit 120.

FIG. 2B illustrates another embodiment of FIG. 2A. As shown in FIG. 2B, in order to describe the capabilities of the current invention, the sensor units 110 and the controller units 120 have been grouped as groups A, B, and C, while the UI units 140 are grouped as UI units A, B, and C. As shown in FIG. 2B, group A, the server unit 130, and the UI unit 140A is the embodiment shown in FIG. 2A. In comparison to group A, group B has more sensor units 110 (as shown in FIG. 2B of the sensor units 110B1 and 110B2). In the present embodiment, the sensor units 110B1 and 110B2 of group B will each transmit their data messages to the server unit 130, wherein the server unit 130 will follow the procedure described previously and transmit the data messages to the UI unit 140B. In the present embodiment, the server unit 130 separately transmits the data messages of the sensor units 110B1 and 110B2 to the UI unit 140B. However, in other different embodiments, the server unit 130 may also combine the data messages from the sensor units 110B1 and 110B2 into an aggregate data message, transmitting it to the UI unit 140B. In other words, the server unit 130 is able to receive data messages from a plurality of sensor units 110 (ex. sensor units 110B1 and 110B2), aggregating them into the aggregate data message to transmit to the UI unit 140B. However, if other UI units 140 (ex. UI units 140A or 140C) also request of the server unit 130 for the data messages from sensors 110B1 and/or 110B2 of group B, the server unit 130 would also transmit to them the requested data messages.

As shown in group C in FIG. 2B, group C includes a plurality of controller units 120 (controller units 120C1 and 120C2). It should be noted that the present figure is provided to better describe the characteristic of the present invention and should not be construed to be limiting of the scope of the invention. As shown in group C of the figure, the number of sensor units 110C is preferably lower than the number of controller units 120 (120C1 and 120C2). However, the present invention is not limited to only having a single sensor unit 110. In the present embodiment, the UI unit 140C requests of the server unit 130 for the data message from the sensor unit 110C in group C. The UI unit 140C then generates a controller command message according to the user setting and data message. In the present embodiment, the UI unit 140C generates an aggregate controller command that includes a plurality of target CIDs and their control instructions. UI unit 140C will transmit the aggregate controller command to the server unit 130 where the server unit 130 will decode the aggregate controller command into their individual controller command messages and transmit them to controller units 120C1 or 120C2 corresponding to the target CIDs in those controller command messages. However, in other different embodiments, the UI unit 140C may also separately transmit those controller command messages to the server unit 130. In other embodiments, the UI unit 140C may also request and receive data messages from sensor units in different groupings as well as transmit control command messages to controller units in different groupings. In other words, as an example, UI unit 140A may receive data message from sensor unit 110B1 and/or 110B2 from group B, and then transmit commands to controller unit 120C1 and/or 120C2 of group C.

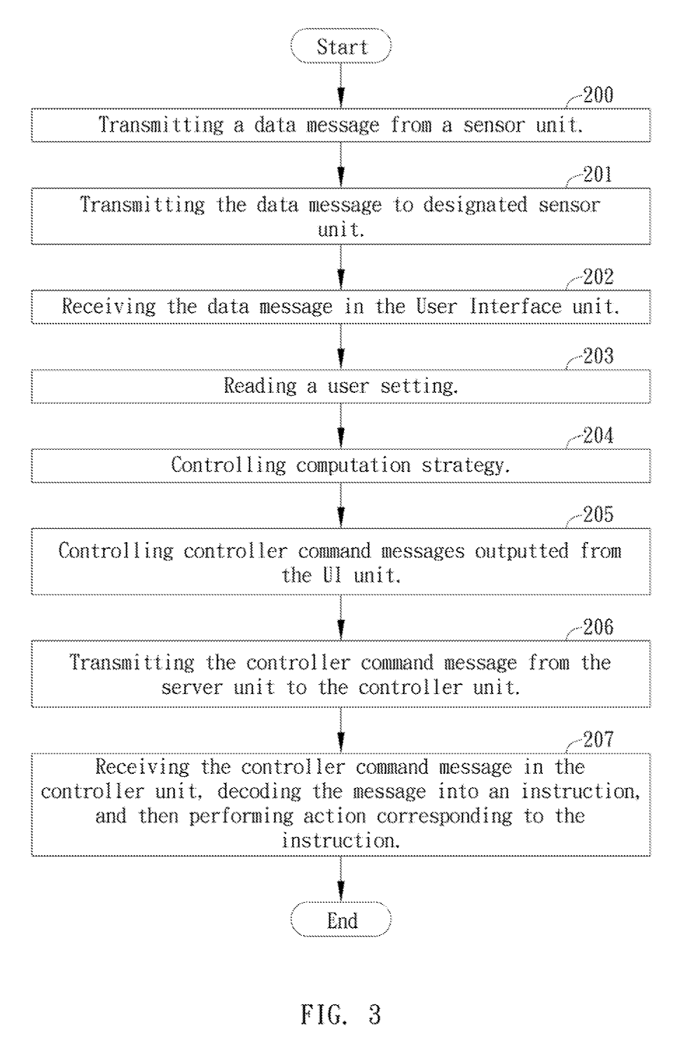

FIG. 3 is a flowchart diagram of a straight form (FIG. 2A embodiment) of the monitoring system 100. As shown in FIG. 3, step 200 includes transmitting the data message from the sensor unit 110. Step 201 includes the server unit 130 transmitting the data message to the designated UI unit 140. Step 202 includes the UI unit 140 receiving the data message. Step 203 includes reading the user setting inputted by users. Step 204 includes controlling computation strategy. Step 205 includes controlling controller command messages outputted from the UI unit 140. Step 206 includes the server unit 130 transmitting the controller command message to the controller unit 120. Step 207 includes the controller unit 120 receiving the controller command message and decoding the message into an instruction, and then performing action corresponding to the instruction. The action mentioned here has been described previously above, wherein the controller unit 120 executes an action that can affect the quantifiable data that the sensor unit 110 senses.

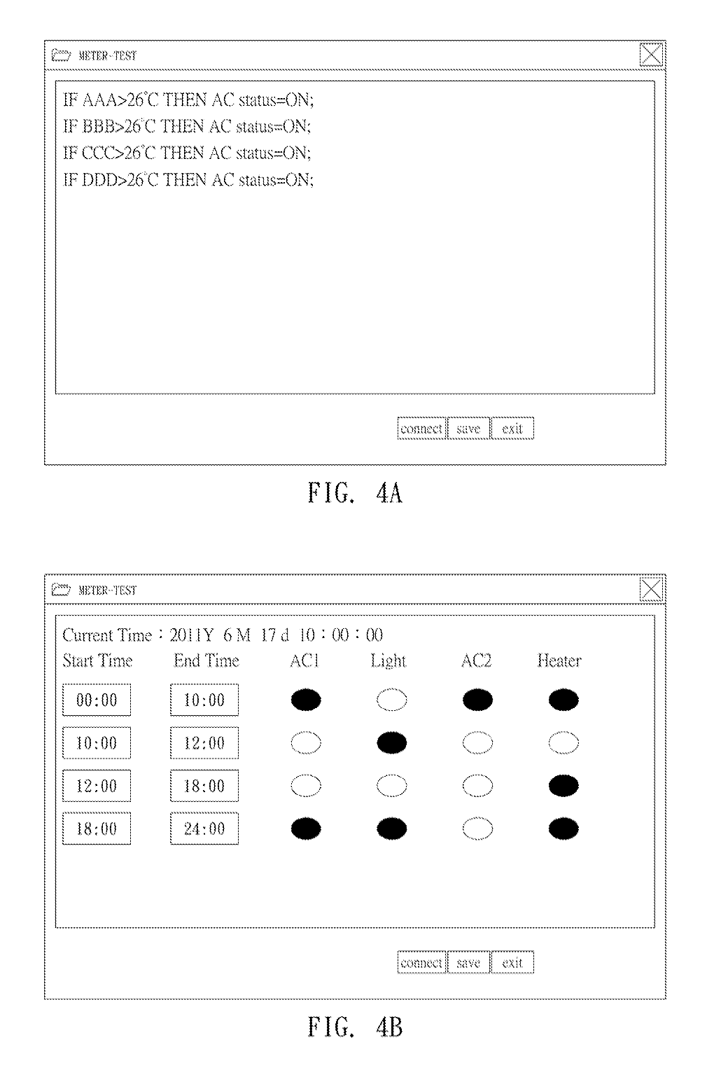

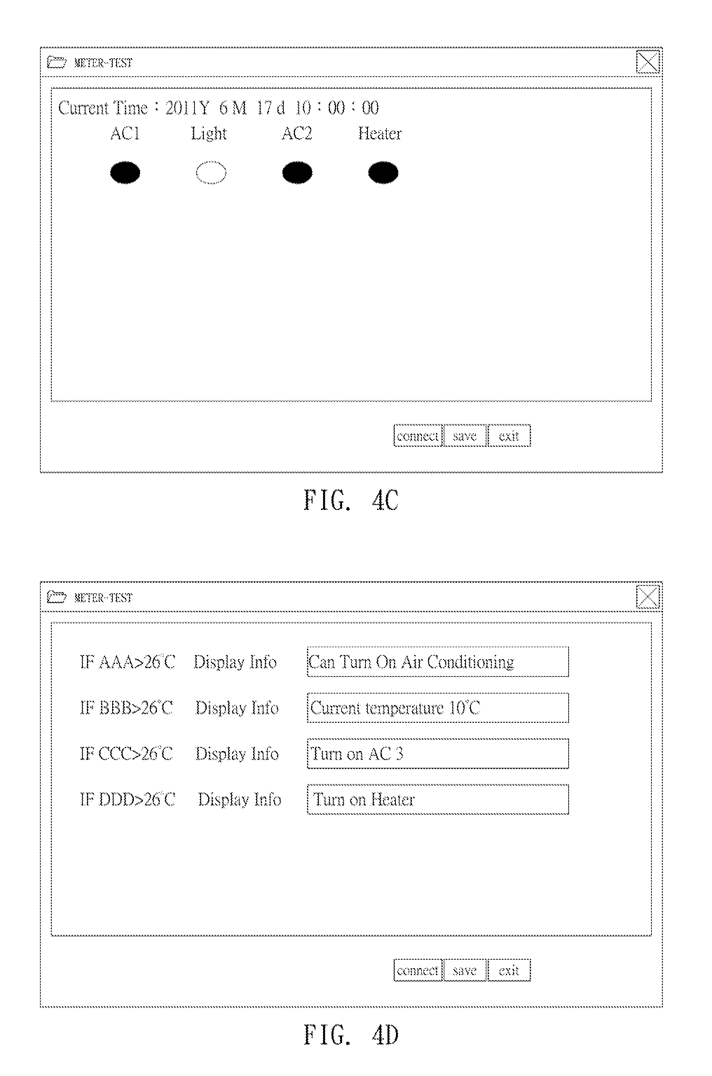

FIGS. 4A and 4B are different embodiments of the UI unit 140. The following describes the characteristics of FIGS. 4A and 4B.

As shown in FIG. 4A in one embodiment, the UI unit 140 includes text user interface of an electronic device, realized through software. As shown in FIG. 4A, users may utilize the blank area or textbox to directly input textual rules of command, wherein the command rules is not limited to any one programming instruction seen on the market. For instance, the present invention can accommodate programming instructions or commands in Java, JavaScript, C++, Visual Basic, or the like without limitation. As shown in FIG. 4A, “IF AAA>26° C. THEN AC status=ON;” is a pseudo-code. A characteristic of the present invention of the monitoring system 100 is that it allows users the flexibility to design and define the manner in which they would like to input instruction or command rules. If users would like to input logic computation rules in the Java programming language, users would only need to design the related logic computation user interface of the textual interface on any electronic device (such as a smart phone, or through phone messages like SMS or MMS to input and transmit textual input). In this manner, users can simply, conveniently, and easily learn or through users' customary/preferred method to realize input of rules for energy conservation settings.

As shown in FIG. 4B of another embodiment of the UI unit 140, the UI unit 140 may also be designed by users to be a graphical user interface (GUI). As shown in the user interface of FIG. 4B, users may select a default time period in which to activate or shut off each type of temperature, light, or the like of electronic devices. In other words, users can design the scope of rules of the settings to their liking and then realize the user interface accordingly. In this manner, any user may set energy conservation rules through the user interface. In terms of the embodiment of FIG. 4B as an example, the UI unit 140 requests data messages from sensor units 110 according to the time set, and then taking the rules that the user had set into consideration (ex. 3^{rd} line of the inner frame of the user interface: activate AC1, AC2, and Heater), the UI unit 140 then generates the controller command message.

FIG. 4C is another embodiment of FIG. 4B. As shown in FIG. 4C, designers of the user interface of the UI unit 140 may also design the user interface to limit what settings users may input and set. In comparison to FIG. 4B, the embodiment in FIG. 4C does not allow users to set the time to activate or deactivate rules. In the present embodiment, the user interface is realized through software on an electronic device. However, in other different embodiments, the user interface may be realized through the hardware, such as buttons provided to users to input rules settings.

FIG. 4D is another embodiment of the user interface of the UI unit 140. As shown in FIG. 4D, the rules of the settings were already predetermined and set as the default setting. Users are only able to view data of the sensor unit 110 and the controller unit 120. For instance, in the first line of FIG. 4D, when “AAA” is greater than 25° C., through the controller unit 120, the UI unit 140 will display info as “Can Turn On Air Conditioning”. However, in other different embodiments, the long rectangular frame to the right of “Display Info” may be a pull-down selection box to provide users with a list of rules settings to select.

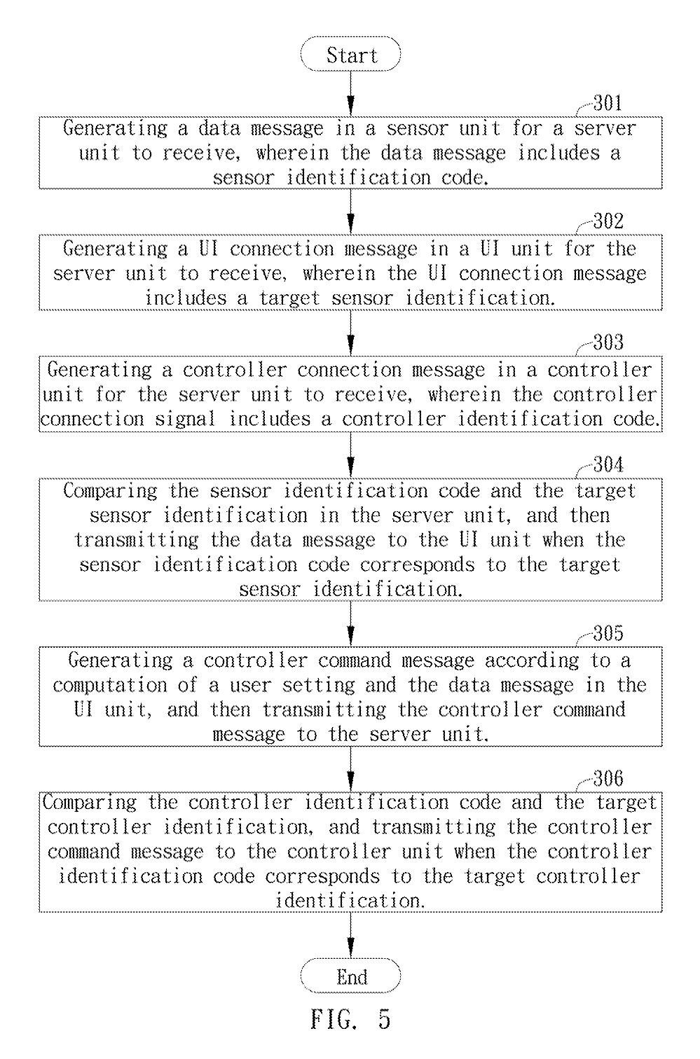

FIG. 5 is a flowchart diagram of the operating method of the monitoring system of the present invention. As shown in FIG. 5, the operating method of the monitoring system includes the following steps:

Step 301 includes generating the data message in the sensor unit 110 for the server unit 130 to receive, wherein the data message includes the sensor identification code (SIC). In a preferred embodiment, the server unit 130 may be an electronic device or server, such as a computer, a corporate enterprise level server, or the like. When the sensor unit 110 senses data or environmental changes, the sensor unit 110 will generate the data message and immediately transmit it to the server unit 130. The SIC is preferably the identification code of the sensor unit 110. The SIC may be composed of letters and/or numbers such as “AAA”, “1234”, or “A1B3”. In the present embodiment, each sensor unit 110 has a unique SIC. However, the present invention is not limited in this respect as in other different embodiments there could be a plurality of sensor units 110 having similar SIC.

Step 302 includes generating a UI connection message in the UI unit 140 for the server unit 130 to receive, wherein the UI connection message includes the target sensor identification (target SIC). In a preferred embodiment, the UI connection message is generated in the UI unit 140 to allow the server unit 130 to know the location of the UI unit 140. Since the UI unit 140 of the monitoring system 100 of the present invention may have either a dynamic or static IP address, the server unit 130 would not necessarily know the location of the UI unit 140 or whether if the UI unit 140 in question even exists. Through the transmission of the UI connection message, the server unit 130 is able to know the IP address of the UI unit 140. In the present embodiment, the UI unit 140 may be connected to the server unit 130 through a cable network, a wireless network (such as WIFI), Zigbee, Zwave, Bluetooth, or the like.

Step 303 includes generating the controller connection message in the controller unit 120 for the server unit 130 to receive. The controller connection message includes the controller identification code (CID). In a preferred embodiment, the controller unit 120 is a controller that can output actions or signals. The CID of the controller connection message has similar uses to the mentioned SID, wherein it lets the server unit 130 know the controller unit 120 exists as well as its IP address. In the present embodiment, the controller unit 120 has a dynamic IP address. The controller unit 120 periodically transmits the controller connection message periodically to the server unit 130 such that the server unit can know the IP address of the controller unit 120 as well as the CID. The CID is similar to the SID in that it is composed of numbers and/or letters. In the present embodiment, each controller unit 130 has a unique CID in the monitoring system 100. However, the present invention is not limited in this aspect as in other different embodiments, the monitoring system 100 could have a plurality of controller units 120 having similar CIDs. In addition, the controller connection message may further include a password combination, while the controller command message may further include a target controller login password. The purpose of this is to provide the monitoring system 100 of the present invention an authentication security to prevent users without rights to the monitoring system 100 to use the resources and services of the monitoring system 100.

Step 304 includes comparing the SIC and the target SID in the server unit 130. When the SIC corresponds with the target SID, the server unit 130 transmits the data message it received from the sensor unit 110 to the UI unit 140. In a preferred embodiment, the server unit 130 receives the SIC and target SID from the sensor unit 120 and the UI unit 140, wherein the target SID represents the sensor unit 110 that the UI unit 140 would like to indirectly connect to (through the server unit 130). In other words, it is the sensor unit 110 that the UI unit 140 would like to receive data messages from. In this situation, the server unit 130 will first compare the target SID with the SIC to confirm whether or not they are referring to the same sensor unit 110. When the server unit 130 confirms that the target SID matches or corresponds to the SIC, the server unit 130 will transmit the data message it received from the sensor unit 110 to the UI unit 140.

Step 305 includes generating a controller command message according to a computation of the user setting and the data message in the UI unit 140, and then transmitting the controller command message from the UI unit 140 to the server unit 130. In a preferred embodiment, the controller command message is generated in the UI unit 140. The purpose of this is to transfer the logic computational action of data analysis to the UI unit 140 away from the server unit 130. In this manner, the present invention of the monitoring system 100 can scale up in without putting too much of the load on the server unit 130 (i.e. scalable). In addition, since the logic computation and processing action has been transferred to the UI unit 140 side, when users require changes be made to the logic processing or if users would like to utilize other different sensors or controllers, users would need not make any changes to the server unit 130 in order to complete those changes. Users would only be required to update or revise logic processing/computation in the software or hardware of the UI unit 140 that they are using to connect to the monitoring system 100 in order to realize those changes.

Step 306 includes comparing the controller identification code (CID) and the target controller identification (target CID), and transmitting the controller command message to the controller unit 120 when the CID corresponds to the target CID. In a preferred embodiment, the server unit 130 will first execute the above comparing action. Once the server unit 130 determines and confirms that the CID matches or corresponds to the target CID, the server unit 130 will transmit through the Internet the controller command message to the controller unit 120 corresponding to the target CID. The controller unit 120 can be a controller that controls or affects electrical voltage, electrical current, electrical resistance, frequency, acceleration, capacitance, induction, conductance, temperature, sound, light, or any combination thereof. The monitoring system 100 of the present invention may further include the controller unit 120 transmitting a control action/instruction or signal according to the control command message. For example, the controller unit 120 can output a control action/instruction according to the instruction of the controller command message, such as shutting down or deactivating an air conditioning. In an embodiment, the scope or range that the controller unit 120 controls is related with the sensor unit 110 that it is grouped in. For instance, if the sensor unit 110 senses temperature, the scope or range that the controller unit 120 controls is preferably related to temperature, such as activating/deactivating air conditioning. However, in other different embodiments, the controller unit 120 does not necessarily need to be related to the sensor unit 110 it is grouped with. In other words, the control action/instruction of the controller unit 120 does not necessarily have to affect the data or environment which the sensor unit 110 that it is grouped with senses.

The monitoring system 100 of the present invention has the following advantages:

Firstly, since the monitoring system 100 is connected through the Internet, the actual locations of the sensor units 110, the controller units 120, the server unit 130, and the UI units 140 may be completely different. Users would only need to connect new sensor units 110, controller units 120, and/or UI units 140 to the Internet to connect to the monitoring system 100. The advantage of this is that the server unit 130 and the UI unit 140 need not be restricted to be in the vicinity of the sensor unit 110 and controller unit 120. The UI unit 140 also does not need to be limited to being located near the server unit 130.

The second advantage to the present invention is that since the sensor units 110, the controller units 120, and the UI units 140 have records of the static IP address of the server unit 130, they would still be able to easily and simply connect to the server unit 130 even if the server unit 130 was placed behind a firewall. In this manner, users need not worry or frustrate about modifying the setting of the firewall to allow the sensor units 110, controller units 120, or UI units 140 to connect with the server unit 130. Simply stated, the present invention of the sensor unit 110, the controller unit 120, and the UI unit 140 only need to be plugged into the Internet through wireless or non-wireless means to simply and quickly connect with the server unit 130 to form the monitoring system 100.

The third advantage to the present invention lies in that since the server unit 130 does not record beforehand the IP addresses of the sensor unit 110, the controller unit 120, and the UI unit 140, relying instead on these units to proactively notify the server unit 130 of their IP addresses by utilizing the static IP address of the server unit 130 that they have on record, users need not worry about having to reset each of these units' connection settings to the server unit 130 if the structure of the monitoring system 100 ever changes. In this manner, users may simply and quickly increase or decrease the number of sensor units 110, controller units 120, or UI units 140.

The fourth advantage of the present invention is that since the server unit 130 does not need to handle the task of logic computation processing (i.e. energy conservation rules interpretation), nor does the server unit 130 need to store data messages or records of the IP addresses of the sensor units 110, controller units 120, and UI units 140 long-term, the loading on the server unit 130 of the present invention is significantly less in comparison to the prior art. As a result, the monitoring system 100 provides advantages of having greater flexibility, processing speed, higher efficiency, and greater scalability. Users may increase the number of sensor units 110, controller units 120, and UI units 140. As well, even though different UI units 140 may have different energy conservation rules to carry out, they will not adversely affect the workings of the server unit 130.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A monitoring system, comprising:
at least a sensor unit for generating a data message, the data message includes a sensor identification code;
at least a controller unit for generating a controller connection message and receiving a controller command message, the controller connection message includes a controller identification code;
at least one user interface unit for receiving the data message and for generating an user interface connection message and the controller command message, the user interface unit generates the controller command message according to the data message and an user setting, the user interface connection message includes a target sensor identification, the controller command message includes a target controller identification; and
a server unit for receiving the data message, the controller connection message, the user interface connection message, and the controller command message;
wherein when the sensor identification code of the data message corresponds to the target sensor identification of the user interface connection message, the server unit transmits the data message to the user interface unit where the user interface unit generates the controller command message according to the data message and the user setting and then transmits the controller command message to the server unit; when the controller identification code of the controller connection message corresponds to the target controller identification of the controller command message, the server unit transmits the controller command message to the controller unit.

2. The monitoring system of claim 1, wherein the user interface unit is a visualization of electrical signals from an electronic device and from control inputs of the controller unit.

3. The monitoring system of claim 1, wherein the user interface unit comprises a human-machine interface having physical buttons for inputting of editable text or graphical labels that represent instructions to generate the controller command.

4. The monitoring system of claim 1, wherein the sensor unit, the user interface unit, and the server unit communicates through the Internet, WiFi, Zigbee, Zwave, or Bluetooth.

5. The monitoring system of claim 4, wherein the communication address of the server unit is a static Internet Protocol address or a network location that may be addressed, and the communication addresses of the sensor unit, the controller unit, and the user interface unit are static Internet Protocol address or network locations that are addressable.

6. The monitoring system of claim 1, wherein the sensor unit is a sensor of electrical voltage, electrical current, electrical resistance, frequency, acceleration, electrical capacitance, inductance, conductance, acidity, temperature, sound tone, humidity, light, or a combination thereof.

7. The monitoring system of claim 1, wherein the controller connection message further includes a password combination, the controller command further includes a target controller login password.

8. The monitoring system of claim 1, wherein the server unit receives combines data messages received from a plurality of the sensor units into an aggregate data message and then transmits the aggregate data message to the user interface unit.

9. The monitoring system of claim 1, wherein the server unit receives an aggregate controller command from the user interface unit, the server unit decodes the aggregate controller command into a plurality of the controller commands and then transmits the plurality of controller commands to a plurality of the controller units.

10. The monitoring system of claim 1, wherein the user interface unit is a computer or smart phone having a user interface.

11. An operating method for a monitoring system, wherein the monitoring system includes at least a sensor unit, at least a controller unit, a server unit, and at least a user interface unit, the operating method comprises:
generating a data message in the sensor unit for the server unit to receive, wherein the data message includes a sensor identification code;
generating a user interface connection message for the server unit to receive, wherein the user interface connection message includes a target sensor identification;
generating a controller connection message in the controller unit for the server unit to receive, wherein the controller connection message includes a controller identification code;
comparing the sensor identification code and the target sensor identification, and then enabling the server unit to transmit the data message to the user interface unit when the sensor identification code corresponds to the target sensor identification;
generating a controller command in the user interface unit according to a user setting and the data message, and then transmitting the controller command to the server unit; and
comparing the controller identification code and the target controller identification, and transmitting the controller command message to the controller unit when the controller identification code corresponds to the target controller identification.

12. The operating method of claim 11, wherein the communication between the electronic module, the user interface unit, and the server unit is through the Internet, WiFi, Zigbee, Zwave, or Bluetooth.

13. The operating method of claim 11, wherein the a communication address of the server unit is a static Internet Protocol address or an addressable internet address, the communication address of the sensor unit, the controller unit, and the user interface unit are addressable internet addresses or dynamic Internet Protocol addresses.

14. The operating method of claim 11, wherein the sensor unit is a sensor of electrical voltage, electrical current, electrical resistance, frequency, acceleration, electrical capacitance, inductance, conductance, acidity, temperature, sound tone, humidity, luminance, or a combination thereof.

15. The operating method of claim 11, wherein the controller connection message further includes a password combination, the controller command further includes a target controller login password.

16. The operating method of claim 11, further comprising:
combining data messages from a plurality of the sensor units into an aggregate data message, and then transmitting the aggregate data message to the user interface unit.

17. The operating method of claim 11, further comprising:
decoding an aggregate control command into a plurality of controller command messages, and then transmitting the controller command messages to corresponding controller units.

18. The operating method of claim 11, wherein the user interface unit is a visualization of electrical signals from an electronic device and from control inputs of the controller unit.

19. The operating method of claim 11, wherein the user interface unit comprises a human-machine interface having physical buttons for inputting of editable text or graphical labels that represent instructions to generate the controller command.
